(19) United States
(12) Patent Application Publication
(10) Pub. No.: US 2025/0084980 A1
(43) Pub. Date: Mar. 13, 2025

(54) LIGHTING APPARATUS

(71) Applicant: LEEDARSON LIGHTING CO.,LTD., Zhangzhou (CN)

(72) Inventors: Lindong Lu, Zhangzhou (CN); Yanzeng Gao, Zhangzhou (CN)

(21) Appl. No.: 18/823,983

(22) Filed: Sep. 4, 2024

(30) Foreign Application Priority Data
Sep. 7, 2023 (CN) 202322433194.1

(51) Int. Cl. F21V 5/00; F21V 7/00; F21V 14/02; F21V 17/16; F21V 23/00; F21V 23/04; F21Y 105/18; F21Y 113/13; F21Y 115/10

(52) U.S. Cl. CPC F21V 5/007; F21V 7/0066; F21V 7/0091; F21V 14/02; F21V 17/16; F21V 23/04; F21V 23/003; F21Y 2105/18; F21Y 2113/13; F21Y 2115/10

(57) ABSTRACT

In some embodiments, a lighting apparatus includes a light source plate, a first LED module, a second LED module, a plastic cover and a controller. The first LED module is mounted on a first area of the light source plate. The second LED module is mounted on a second area of the light. The plastic cover has a first region facing to the first LED module for forming a first light spanning region. The plastic cover has a second region facing to the second LED module for forming a second light spanning region. The controller generates a first driving current to the first LED module and a second driving current to the second LED module. The controller adjusts a ratio between the first driving current and the second driving current to create a mixed light spanning region with a required mixed light pattern.

### FIELD

The present invention is related to lighting apparatus, and more particularly related to a lighting apparatus with a flexible control of light pattern.

### BACKGROUND

The development and widespread adoption of LED (Light Emitting Diode) technology have significantly impacted the design and functionality of modern light devices. Initially introduced in the mid-20th century, LEDs were primarily utilized in low-power indicator lights due to their small size and efficiency. However, as the technology advanced, LEDs have evolved to become a cornerstone of various lighting applications, including general illumination, automotive lighting, display screens, and more. The shift from traditional incandescent and fluorescent lighting to LEDs has been driven by several key factors, including energy efficiency, longevity, and environmental considerations.

One of the primary advantages of LED technology is its remarkable energy efficiency. LEDs convert a higher percentage of electrical energy into visible light compared to traditional lighting sources, which often waste a significant portion of energy as heat. This efficiency not only reduces energy consumption but also lowers operational costs, making LEDs an attractive option for both residential and commercial applications. The reduction in energy usage also contributes to decreased carbon emissions, aligning with global efforts to combat climate change and reduce environmental impact.

In addition to energy efficiency, LEDs are known for their long lifespan. Unlike incandescent bulbs, which may last only a few thousand hours, LEDs can operate for tens of thousands of hours before needing replacement. This extended lifespan reduces maintenance costs and the frequency of bulb replacements, particularly in applications where changing bulbs is inconvenient or costly, such as in street lighting or high-ceiling installations. The durability and reliability of LEDs have made them a preferred choice in industries where consistent performance is critical.

The versatility of LED technology has led to its adoption in a wide range of applications beyond traditional lighting. In the automotive industry, for example, LEDs are used in headlights, taillights, and interior lighting due to their brightness, quick response time, and ability to be shaped into various forms. The compact size of LEDs allows for innovative design possibilities, enabling manufacturers to create sleek, modern lighting solutions that enhance the aesthetic appeal of vehicles. Additionally, the low power consumption of LEDs is particularly beneficial in electric vehicles, where energy efficiency is paramount.

LEDs have also revolutionized the design of display screens, including those used in televisions, smartphones, and digital billboards. The ability to produce vibrant colors, high contrast ratios, and deep blacks has made LEDs a superior choice for display technology.

Furthermore, advancements in micro-LED and OLED (Organic LED) technologies have pushed the boundaries of what is possible in screen design, offering thinner, more flexible displays with improved color accuracy and energy efficiency. These developments have not only enhanced user experiences but also opened new opportunities for creative content delivery.

In the field of general illumination, LEDs have rapidly replaced traditional bulbs in homes, offices, and public spaces. The introduction of smart LED bulbs has further expanded the capabilities of lighting systems, allowing users to control brightness, color temperature, and even the color of light through mobile apps or voice commands. This integration of LED technology with smart home systems has made lighting more adaptable to individual preferences and needs, enhancing comfort and convenience in daily life. Moreover, the ability to dim LEDs without compromising efficiency extends their usefulness in various settings, from creating ambiance in living spaces to reducing energy consumption in commercial environments.

The environmental benefits of LED technology are significant, particularly when considering the materials used in manufacturing. LEDs do not contain hazardous substances such as mercury, which is commonly found in fluorescent bulbs. This makes LEDs safer to handle and dispose of, reducing the risk of environmental contamination. Additionally, the reduction in energy consumption associated with LED lighting contributes to decreased demand for electricity, which in turn lowers the strain on power plants and reduces greenhouse gas emissions. As sustainability becomes an increasingly important consideration in product design, the eco-friendly nature of LEDs continues to drive their adoption across various industries.

LED technology has also enabled the development of innovative lighting solutions that were previously impossible or impractical. For example, the ability to produce light in specific wavelengths has made LEDs invaluable in horticulture, where they are used to optimize plant growth by providing tailored light spectra. Similarly, in medical applications, LEDs are employed in devices for phototherapy, surgical lighting, and diagnostic imaging, where precise control over light intensity and color is crucial. These specialized applications demonstrate the versatility of LEDs and their potential to address unique challenges in various fields.

The ongoing research and development in LED technology continue to push the boundaries of what is possible in light device design. Advances in materials science, such as the development of more efficient phosphors and quantum dot technology, have led to improvements in LED color rendering and brightness. Additionally, efforts to reduce manufacturing costs and improve production processes have made LEDs more accessible and affordable, further accelerating their adoption. As LED technology matures, it is expected that new applications and innovations will emerge, driving further transformation in how light is used and perceived.

In architectural lighting, LEDs have enabled designers to explore new possibilities in creating dynamic and responsive environments. The ability to control the intensity, color, and direction of light with precision allows for the creation of immersive experiences that can enhance the atmosphere of a space. Whether in residential settings, commercial buildings, or public installations, LED technology offers unparalleled flexibility in lighting design, enabling the creation of spaces that can adapt to the changing needs of occupants or the specific requirements of an event. This adaptability has made LEDs a key tool in modern architectural design, where the integration of lighting with other building systems is increasingly important.

Finally, the impact of LED technology on the global lighting industry cannot be overstated. The rapid shift from traditional lighting sources to LEDs has not only transformed the market but also spurred significant investment in research and development. This has led to continuous improvements in LED performance, cost, and availability, making them the dominant technology in the lighting sector. As the demand for energy-efficient and environmentally friendly lighting solutions continues to grow, LEDs are poised to remain at the forefront of innovation, driving further advancements in light device design and shaping the future of how light is used in both everyday and specialized applications.

In the design of light devices, lenses and other optical components play a critical role in directing and shaping light to produce desired patterns and effects. These components, which can include lenses, diffusers, reflectors, and prisms, are used to control the distribution, intensity, and focus of light emitted by LEDs. By carefully selecting and positioning these optical elements, designers can create specific lighting patterns tailored to various applications, such as spotlighting, ambient lighting, or decorative effects. The ability to manipulate light in this manner allows for greater versatility and precision in lighting design, enabling the creation of both functional and aesthetically pleasing light environments.

Lenses are perhaps the most commonly used optical components in LED lighting systems. They are typically made from materials such as glass or plastic and are designed to focus or disperse light in a controlled manner. The shape and curvature of a lens determine how it bends light rays, which can be used to concentrate light into a narrow beam or spread it out over a wide area. In applications such as stage lighting or architectural illumination, lenses are essential for directing light exactly where it is needed, enhancing the effectiveness and impact of the lighting design.

Reflectors are another important optical component used to direct light. Unlike lenses, which transmit light, reflectors bounce light off their surfaces to achieve the desired distribution. Reflectors are often used in conjunction with lenses to enhance light output and improve efficiency. For example, in automotive lighting, reflectors are used to focus the light from LEDs into a beam pattern that maximizes visibility while minimizing glare. The design and material of reflectors are carefully chosen to optimize the reflection of light, ensuring that as much light as possible is directed towards the target area.

Diffusers are used to soften and spread light, reducing harsh shadows and creating a more uniform light distribution. They are particularly useful in applications where even illumination is desired, such as in office lighting or backlighting for displays. Diffusers are typically made from materials like frosted glass or plastic, which scatter light as it passes through. This scattering effect helps to reduce the intensity of the light and create a more pleasant, diffused glow. The use of diffusers in LED lighting design is crucial for achieving the right balance between brightness and comfort, making spaces more inviting and visually appealing.

Prisms and other specialized optical elements can also be used to create unique light patterns and effects. For instance, prisms can be employed to split light into its component colors, creating a rainbow effect, or to bend light in specific directions. These optical components are often used in decorative lighting or in applications where visual impact is important. By incorporating such elements into LED lighting designs, manufacturers can offer products that not only provide functional lighting but also enhance the aesthetic experience.

It is important to properly dispose of lenses and other optical components at the end of their lifecycle to minimize environmental impact. Many of these components are made from materials that can be recycled or repurposed, reducing the need for new resources and limiting waste. Additionally, improper disposal of optical components can lead to environmental contamination, particularly if they contain hazardous materials or coatings. Responsible disposal practices are essential to ensure that the benefits of LED technology are not offset by negative environmental consequences.

Cost is an important concern in the design and production of optical components for LED lighting. High-quality lenses, reflectors, and diffusers can be expensive to manufacture, and these costs can significantly impact the overall price of a lighting product. To remain competitive, manufacturers must carefully balance performance with cost, ensuring that the optical components used in their designs are both effective and affordable. Innovations in manufacturing processes and materials are continuously being explored to reduce costs without compromising quality, allowing LED lighting to remain accessible to a wide range of consumers.

Finally, it is beneficial if flexible design options can be provided in LED lighting systems. The ability to customize and adapt optical components to different applications allows for greater versatility and functionality. For example, modular optical systems that can be easily reconfigured or adjusted offer significant advantages in settings where lighting needs may change over time. Flexibility in design not only enhances the usability of LED lighting products but also extends their lifespan by allowing them to be repurposed or upgraded as needed. As the demand for adaptable and multifunctional lighting solutions continues to grow, the development of flexible optical components will play a key role in meeting these needs.

### SUMMARY

In some embodiments, a lighting apparatus includes a light source plate, a first LED module, a second LED module, a plastic cover and a controller.

The first LED module is mounted on a first area of the light source plate.

The second LED module is mounted on a second area of the light.

The plastic cover has a first region facing to the first LED module for forming a first light spanning region.

The plastic cover has a second region facing to the second LED module for forming a second light spanning region.

The controller generates a first driving current to the first LED module and a second driving current to the second LED module.

The controller adjusts a ratio between the first driving current and the second driving current to create a mixed light spanning region with a required mixed light pattern.

In some embodiments, the ratio is adjusted to create a different mixed light pattern.

In some embodiments, a first ratio between the first driving current and the second driving current corresponds to a first mixed light pattern.

A second ratio between the first driving current and the second driving current corresponds to a second mixed light pattern.

More than 80% of light in the first mixed light pattern is within a first continuous output region.

More than 80% of light in the second mixed light pattern is within a second continuous output region.

The first continuous output region is enclosed by the second continuous output region.

In some embodiments, the first region of the plastic cover has a first lens.

The second region of the plastic cover has a second lens.

In some embodiments, the first lens and the second lens are TIR lenses.

In some embodiments, the second LED module includes multiple LED units surrounding the first LED module.

In some embodiments, a separate LED unit is disposed on the plastic unit facing to each LED unit.

In some embodiments, the multiple separate LED units form a tilt angle for directing light.

In some embodiments, the plastic cover is rotatable with respect to a main housing that holds the light source plate to change a tilt direction of a mixed output light of the first LED module and the second LED module.

In some embodiments, the controller adjusts a ratio between the first driving current and the second driving current according to a manual switch.

In some embodiments, the lighting apparatus may also include a main housing.

The main housing and the plastic cover together enclose the light source plate.

The manual switch is disposed on an exterior surface of the main housing.

In some embodiments, the lighting apparatus may also include handle.

A portion of the handle is disposed on an exterior surface of the main housing.

The handle is operable to move the light source plate to adjust a relative distance between the first LED module to the plastic cover.

In some embodiments, the main housing has a sliding track for the light source plate to move along a light output direction of the first LED module.

In some embodiments, the lighting apparatus may also include a reflection cup.

A bottom end of the reflection cup has a smaller diameter than a top end of the reflection cup.

The reflection cup separates the first LED module from the second LED module.

In some embodiments, the first light spanning region forms a light beam.

The second light spanning region forms a diffusion light.

In some embodiments, the controller has a first working mode in which the second LED module is completely disabled for producing the light beam.

In some embodiments, the controller has a second working mode, in which the second LED module is turned on to emit a second light with a second light intensity have less than 20% of difference from a first light from the first LED module.

In some embodiments, the second LED module has a smaller color temperature than the first LED module.

In some embodiments, the plastic cover has a hook lens.

The hook lens engages the light source plate and has a reverse hook to fix to the light source plate.

In some embodiments, the plastic cover engages an edge of the main housing at a edge connection.

The edge connection and the reverse hook together fix the plastic hook to the main housing.

### BRIEF DESCRIPTION OF DRAWINGS

FIG. 1 illustrates an exploded view of a lighting apparatus.

FIG. 2 illustrates a light source plate example.

FIG. 3 illustrates a plastic cover example.

FIG. 4 illustrates a top view of the plastic cover example.

FIG. 5 illustrates a pole diagram for light pattern.

FIG. 6 illustrates another pole diagram for light pattern.

FIG. 7 illustrates anther pole diagram for light pattern.

FIG. 8 shows another lighting apparatus.

FIG. 9 is a top view of the embodiment in FIG. 8.

FIG. 10 shows a light pattern.

FIG. 11 shows a rotation plastic cover.

FIG. 12A and FIG. 12B show two statuses for adjusting position with a handle.

FIG. 13 shows a fixing structure.

### DETAILED DESCRIPTION

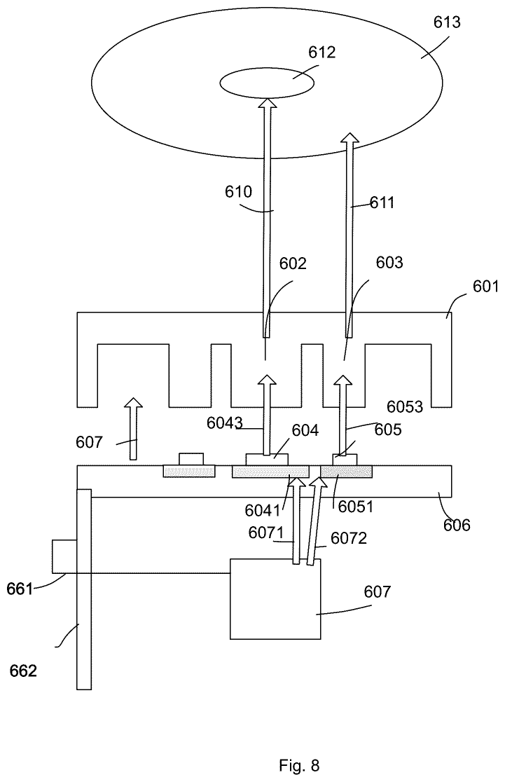

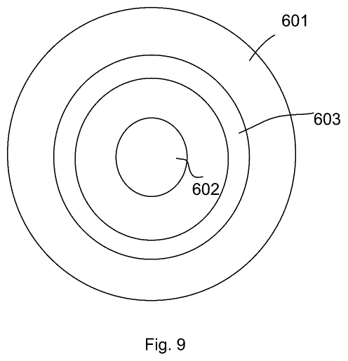

Please refer to FIG. 8 and FIG. 9, where FIG. 9 is a top view of the example of FIG. 8. In the embodiment of FIG. 8 and FIG. 9, a lighting apparatus includes a light source plate 606, a first LED module 604, a second LED module 605, a plastic cover 601 and a controller 607. Please note that the plastic cover 601 may be replaced with other material, e.g. glass material, to be combined with other designs as mentioned below.

The first LED module is 604 mounted on a first area 6041 of the light source plate 606.

The second LED module is mounted on a second area 6051 of the light 606.

Please note that the first LED module 604 and second LED module 605 each may include multiple separate LED units, e.g. LED IC, distributed on required areas.

The plastic cover 601 has a first region 602 facing to the first LED module 604 for forming a first light spanning region 612. The first light 6043 from the first LED module 604 passes through the first region 602 of the plastic cover 601 to a first guided light 610. The second light 6053 from the second LED module 605 passes through the second region 603 of the plastic cover 601 as a second guided light 611.

The plastic cover 601 has a second region 603 facing to the second LED module 605 for forming a second light spanning region 613.

From FIG. 8 and FIG. 9, it is known that the second LED module 605 has multiple LED units surrounding the first LED module 604. Such arrangement makes the first light spanning region 612 may be enclosed by the second light spanning region 613. When the first region 602 and the second region 603 are disposed with different optical components, like condensing lens, diffusion lens, diffusion layer or reflective layer, different light pattern may be mixed.

The controller 607 generates a first driving current 6071 to the first LED module 604 and a second driving current 6072 to the second LED module 605.

The controller 607 adjusts a ratio between the first driving current 6071 and the second driving current 6072 to create a mixed light spanning region with a required mixed light pattern.

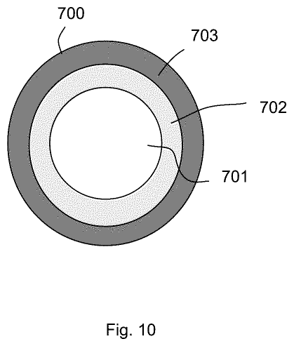

FIG. 10 shows a mixed light pattern 700 that has three areas. The light in inner area 701 is mainly contributed by the first LED module. The light in outer area 703 is mainly contributed by the second LED module. There is a transition area 702 which light is contributed by both the first LED module and the second LED module.

In some embodiments, the ratio is adjusted to create a different mixed light pattern.

In some embodiments, a first ratio between the first driving current and the second driving current corresponds to a first mixed light pattern.

A second ratio between the first driving current and the second driving current corresponds to a second mixed light pattern.

Because output light pattern of a light device is usually a distribution over an area. However, it may be a circle region or a ring region (e.g. when the LED units are arranged in a ring in the example of FIG. 8 and FIG. 9) that covers a major amount of total light output. To make it clear, 80% is adopted here for defining the light pattern regions.

More than 80% of light in the first mixed light pattern is within a first continuous output region, e.g. in a circular region.

More than 80% of light in the second mixed light pattern is within a second continuous output region, e.g. in a ring region.

The first continuous output region is enclosed by the second continuous output region.

FIG. 10 clearly shows such an example.

In some embodiments, the first region of the plastic cover has a first lens.

The second region of the plastic cover has a second lens.

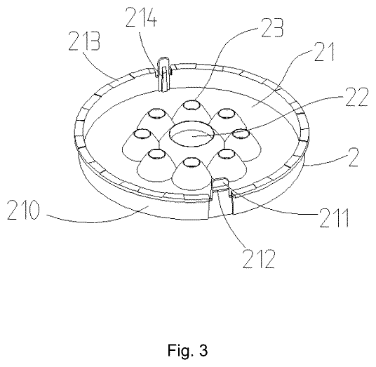

In some embodiments, the first lens and the second lens are TIR lenses. FIG. 3 and its examples will be explained as follows for providing more details.

In some embodiments, the second LED module includes multiple LED units surrounding the first LED module.

In some embodiments, a separate LED unit is disposed on the plastic unit facing to each LED unit.

In some embodiments, the multiple separate LED units form a tilt angle for directing light.

In some embodiments, the plastic cover is rotatable with respect to a main housing that holds the light source plate to change a tilt direction of a mixed output light of the first LED module and the second LED module.

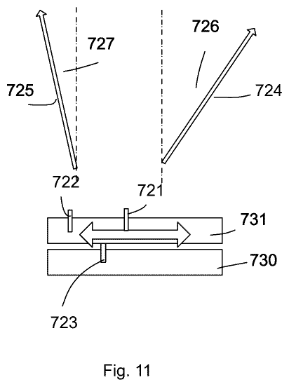

FIG. 11 shows a plastic cover 731 is rotatable with respect to a main housing 730 that is used for fixing the light source plate mentioned above. By rotation, a reference position 721 or another reference position 722 may be aligned with the position 723 of the main housing 730. The plastic cover 731, as mentioned, may have different types of lenses to provide different light guiding effect. When the lens is installed to provide a tilt angle of the output light, e.g. when the reference position 721 of plastic cover 731 aligns with the position 723, an output light 724 with a first tilt angle 726 is provided. When the reference position 722 aligns with the position 723, because the rotation angle, a new tilt angle 727 of a second light 725 is provided. With such design, by rotating the plastic cover, the tilt angle of the output light can be easily achieved. This is particularly helpful if the light is to illuminate a wall decoration or a painting.

In some embodiments, the controller 607 adjusts a ratio between the first driving current and the second driving current according to a manual switch 661.

In some embodiments, the lighting apparatus may also include a main housing 662.

The main housing 662 and the plastic cover 601 together enclose the light source plate 606. FIG. 8 shows an exploded view, the plastic 601 may be placed downwardly along the direction 607 to fix to the light source plate 606.

The manual switch 661 is disposed on an exterior surface of the main housing 662.

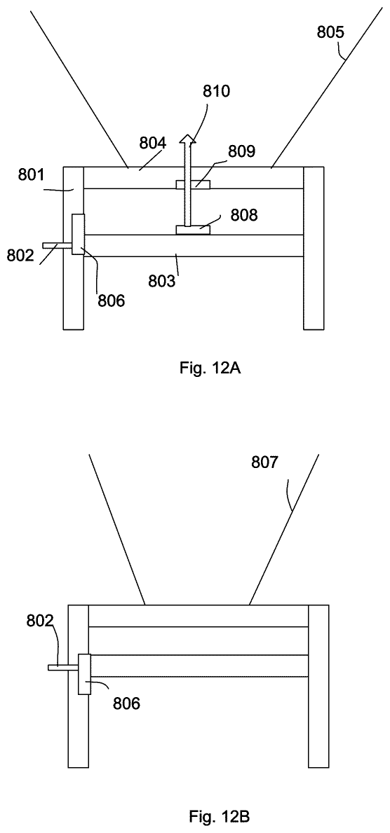

In FIG. 12A and FIG. 12B, the lighting apparatus may also include handle 802.

A portion of the handle 802 is disposed on an exterior surface of the main housing 801.

The handle 802 is operable to move the light source plate 803 to adjust a relative distance between the first LED module to the plastic cover.

In some embodiments, the main housing has a sliding track 806 for the light source plate to move along a light output direction 810 of the first LED module 808.

By using the handle 802 to move the light source plate 808 along the direction 810, the relative distance between the first LED module 808 and the lens 809 is changed thus forming two different light spanning angles 805, 807 in FIG. 12A and FIG. 12B

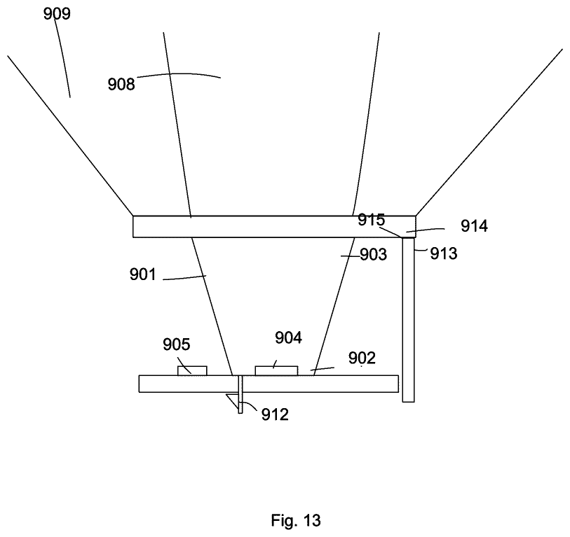

In FIG. 13, the lighting apparatus may also include a reflection cup 901.

A bottom end 902 of the reflection cup 901 has a smaller diameter than a top end 903 of the reflection cup 901 that is away from the first LED module 904.

The reflection cup 903 separates the first LED module 904 from the second LED module 905.

In some embodiments, the first light spanning region forms a light beam 908.

The second light spanning region forms a diffusion light 909.

In some embodiments, the controller has a first working mode in which the second LED module is completely disabled for producing the light beam.

In some embodiments, the controller has a second working mode, in which the second LED module is turned on to emit a second light with a second light intensity have less than 20% of difference from a first light from the first LED module.

In some embodiments, the second LED module has a smaller color temperature than the first LED module.

In some embodiments, the plastic cover has a hook lens.

The hook lens engages the light source plate and has a reverse hook 912, mounted to the reflection cup 903 in this case but may be attached to a column or a lens in other embodiments, to fix to the light source plate.

In some embodiments, the plastic cover 914 engages an edge 915 of the main housing 913 at an edge connection.

The edge connection and the reverse hook 912 together fix the plastic hook to the main housing. In other words, the two connection positions take opposite directions of force and thus keep the components fixed together.

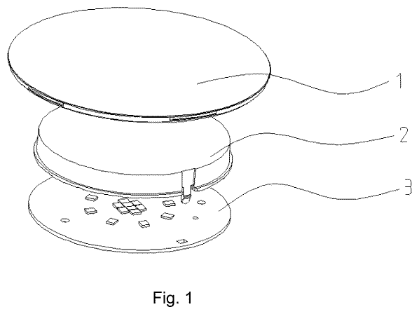

As shown in FIG. 1, the utility model provides an LED spotlight with an adjustable beam angle, comprising: an outer housing 1, which is arranged in sequence and set parallel to each other, used for light homogenization and mixing; a lens assembly 2, used for light concentration; and a light source assembly 3, used for LED illumination and heat dissipation.

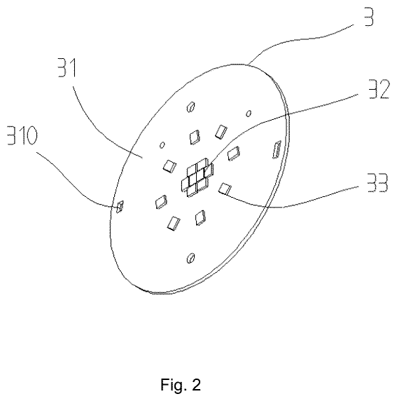

FIG. 2 is a perspective view of the inner side of the light source assembly 3. The light source assembly 3 includes a light source board 31, an inner ring light source 32, and an outer ring light source 33. The inner ring light source 32 and the outer ring light source 33 are both arranged on the inner side of the light source board 31, and the inner ring light source 32 and the outer ring light source 33 are distributed on different circumferences with the same center.

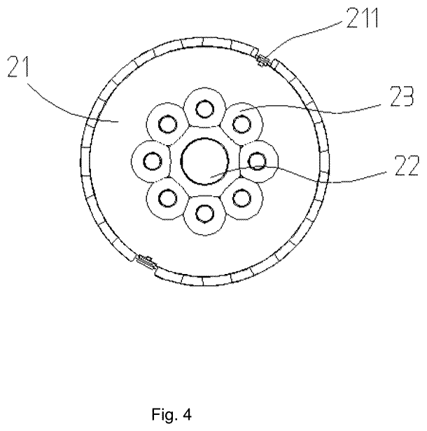

FIG. 3 is a perspective view of the side of the lens assembly 2 facing the light source assembly 3, and FIG. 4 is a side view of the other side of the lens assembly 2. The lens assembly 2 includes a lens board 21, an inner ring lens 22, and an outer ring lens 23. The inner ring lens 22 and the outer ring lens 23 are both arranged on the inner side of the lens board 21, and the inner ring lens 22 and the outer ring lens 23 are distributed on different circumferences with the same center. The projection center of the inner ring light source 32 corresponds to the refraction center of the inner ring lens 22, and the projection center of the outer ring light source 33 corresponds to the refraction center of the outer ring lens 23. The light emitted from the inner ring light source 32 and the outer ring light source 33 is reflected by the inner ring lens 22 and the outer ring lens 23, respectively, forming light rays with different beam angles.

The light source assembly 3 is arranged parallel to the lens assembly 2.

By arranging the light source and the corresponding lens in relative positions on two parallel planes, and setting the inner and outer ring light sources and inner and outer ring lenses with the same center, the projection center of the light source corresponds one-to-one with the reflection center of the lens. This design allows the inner and outer ring light sources to form two different beam angles through the inner and outer ring lenses, respectively. The emitted light with different beam angles overlaps and mixes, enabling changes in the beam angle.

This structure achieves changes in the beam angle without the need for long-distance mechanical adjustments of the lens, saving installation space for the spotlight. Moreover, since all the light sources are on the same plane and the corresponding lenses are also on the same plane with consistent refraction angles, it reduces the issue of ghosting caused by multi-angle refraction.

In a specific embodiment, as shown in FIG. 2 and FIG. 3, the inner ring light source 32 consists of multiple LED chips arranged at the center of the circle, while the outer ring light source 33 consists of a group of multiple LED chips arranged along the circumference of a concentric circle. The inner ring lens 22 is a single lens positioned at the center of the circle, and the outer ring lens 23 is composed of a group of multiple lenses arranged along the circumference of the same concentric circle. The configuration of concentric inner and outer ring LED chips and lenses forms two different beam angles with a simplified structure, saving a significant number of LED chips. Additionally, with the inner ring light source and inner ring lens positioned at the center, the LED chip layout is more concentrated, which helps to reduce ghosting.

In a specific embodiment, as shown in FIG. 4, the outer edges of each adjacent lens in the outer ring lens 23 intersect sequentially, and the outer edge of each lens also intersects with the outer edge of the inner ring lens 22. This intersecting layout between the lenses makes the light source more concentrated, further reducing the occurrence of ghosting.

In a specific embodiment, the inner ring lens 22 and the outer ring lens 23 are total internal reflection lenses. Total internal reflection lenses are conical lenses that reduce energy loss during the refraction process, allowing the light beam to achieve better refraction effects.

In a specific embodiment, the spotlight also includes a control unit (not shown in the figures), which is connected to the light source assembly 3. The control unit is used to control the illumination or shutdown of the inner ring light source 32 and the outer ring light source 33, as well as their light intensity. By adjusting the brightness ratio between the inner ring light source 32 and the outer ring light source 33, the size of the inner and outer ring beam angles can be modulated. After the light beams are mixed and overlapped, a wide range of beam angle adjustments can be achieved.

The mathematical model describing the relationship between the inner and outer ring beam angles and light intensity, as well as the changes in beam angles after mixing and overlapping, is as follows:

Assume the required beam angle is θ. When the LED chips in the inner and outer rings are operating at full current, the central light intensity of the inner ring is a, and the light intensity at an angle of θ/2 is b. Similarly, the central light intensity of the outer ring is c, and the light intensity at an angle of θ/2 is d. Let the brightness proportion of the inner ring be n. After the inner and outer ring beams are mixed, the following equations apply:

$$\frac{na + ( 1 - n ) b}{2} = nc + ( 1 - n ) d \\ n = \frac{2 d - b}{( a - 2 c ) + ( 2 d - b )}$$

When 2d−b=0, n=0, and the beam angle corresponds to the outer ring's beam angle.

When 2d−b≠0, the following equation applies:

$$n = \frac{2 d - b}{( a - 2 c ) + ( 2 d - b )} = \frac{1}{\frac{a - 2 c}{2 d - b} + 1}$$

Since 0≤n≤1, the condition

$$\frac{a - 2 c}{2 d - b} ⩾ 0$$

must be satisfied, which means that either a≥2c and 2d>b, or a≤2c and 2d<b must hold true.

When a=2c, n=1, and the beam angle corresponds to the inner ring's beam angle.

If a>2c and 2d>b, the inner ring's beam angle is smaller than θ, and the outer ring's beam angle is larger than θ.

If a<2c and 2d<b, the inner ring's beam angle is larger than θ, and the outer ring's beam angle is smaller than 0.

Thus, it is possible to achieve a mixed beam angle that lies between the inner and outer ring beam angles (inclusive of the inner and outer ring beam angles).

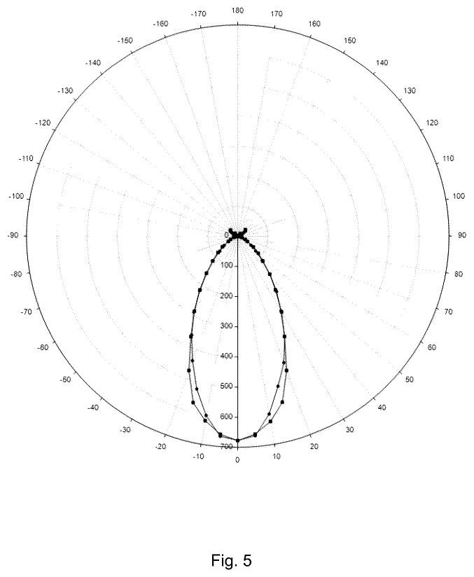

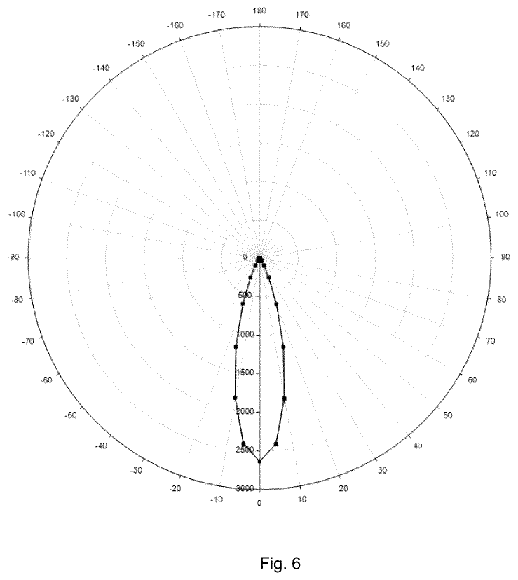

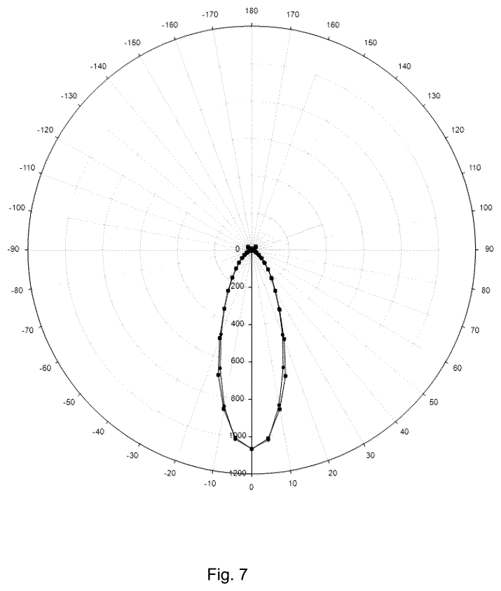

FIG. 5 shows the light distribution curve of the inner ring beam angle, FIG. 6 shows the light distribution curve of the outer ring beam angle, and FIG. 7 illustrates the light distribution curve after the inner and outer ring beam angles are overlaid and mixed. From these figures, it is evident that by controlling the brightness ratio of the inner ring light source 32 and the outer ring light source 33, the size of the inner and outer ring beam angles can be adjusted. After the beams are mixed, a wide range of beam angle adjustments can be achieved.

In a specific embodiment, as shown in FIG. 1, the spotlight also includes an outer housing 1, which is positioned on the outer side of the lens assembly. The outer housing 1 is used for homogenizing and mixing the emitted light, preventing the light from being too glaring.

In another specific embodiment, as shown in FIGS. 2 to 4, the lens board 21 is provided with a protective plate 210 along its outer edge. The protective plate 210 is symmetrically equipped with at least one pair of elastic clips 211, with the free ends of the elastic clips 211 extending outward from the protective plate 210 and featuring latches 212. The light source board 31 has slots 310 at positions corresponding to the elastic clips 211. The width of the slots 310 matches the width of the elastic clips 211. When the light source board 31 and the lens board 21 are assembled, the elastic clips 211 are inserted into the slots 310 and are positioned by the latches 212. This structure simplifies the installation and maintenance of the light source board 31 and the lens board 21, making it more convenient to operate.

The protective plate 210 extends from the outer edge of the lens board 21 toward the light source board 31 in a box-like shape, protecting the light source assembly 3 and the lens assembly 2 from damage while also providing dust and dirt protection. The lower contact surface of the protective plate 210 that touches the light source board 31 can be made wider than the protective plate 210 itself, ensuring a more stable installation of the light source board 31 and the lens board 21.

The elastic clips 211 have gaps on both sides at the connection point with the protective plate 210, which facilitates the insertion of the elastic clips 211 into the slots 310.

In a specific embodiment, as shown in FIG. 3, the inner end surface of the protective plate 210 is equipped with multiple heat dissipation slots 213. The heat dissipation slots 213 function to disperse heat, preventing the spotlight from overheating due to prolonged operation of the light source, thereby extending the lifespan of the components.

In another specific embodiment, continuing to refer to FIG. 3, the inside of the elastic clip 211 is provided with reinforcing ribs 214. The reinforcing ribs 214 serve to enhance the strength of the elastic clips 211, preventing them from breaking due to deformation caused by external forces.

In a specific embodiment, as shown in FIG. 1, the outer housing 1 is detachably connected to the lens assembly 2, facilitating the assembly of the outer housing with the lens board.

Specifically, the detachable connection may include various fitting forms, such as multiple elastic fasteners on the outer edge of the outer housing 1, with corresponding slots on the outer edge of the protective plate 210. During assembly, the elastic fasteners are inserted into the slots and locked in place, and during disassembly, the elastic fasteners are disengaged from the slots by pulling them out.

This embodiment achieves changes in the beam angle by arranging the light source and corresponding lenses on two parallel planes and setting the inner and outer ring light sources and lenses with the same center. The projection center of the light source corresponds one-to-one with the reflection center of the lens, allowing the inner and outer ring light sources to form two different beam angles through the inner and outer ring lenses. The emitted light with different beam angles is mixed and overlaid, enabling beam angle adjustments. This structure eliminates the need for long-distance mechanical adjustments of the lenses to achieve beam angle changes, saving installation space for the spotlight. Additionally, since all the light sources are on the same plane and the corresponding lenses are also on the same plane with consistent refraction angles, it reduces the issue of ghosting caused by multi-angle refraction.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

The invention claimed is:

1. A lighting apparatus, comprising:
a light source plate;
a first LED module, wherein the first LED module is mounted on a first area of the light source plate;
a second LED module, wherein the second LED module is mounted on a second area of the light;
a plastic cover wherein the plastic cover has a first region facing to the first LED module for forming a first light spanning region, wherein the plastic cover has a second region facing to the second LED module for forming a second light spanning region;
a controller, wherein the controller generates a first driving current to the first LED module and a second driving current to the second LED module, wherein the controller adjusts a ratio between the first driving current and the second driving current to create a mixed light spanning region with a required mixed light pattern.

2. The lighting apparatus of claim 1, wherein the ratio is adjusted to create a different mixed light pattern.

3. The lighting apparatus of claim 2, wherein a first ratio between the first driving current and the second driving current corresponds to a first mixed light pattern, wherein a second ratio between the first driving current and the second driving current corresponds to a second mixed light pattern, wherein more than 80% of light in the first mixed light pattern is within a first continuous output region, wherein more than 80% of light in the second mixed light pattern is within a second continuous output region, wherein the first continuous output region is enclosed by the second continuous output region.

4. The lighting apparatus of claim 1, wherein the first region of the plastic cover has a first lens, wherein the second region of the plastic cover has a second lens.

5. The lighting apparatus of claim 4, wherein the first lens and the second lens are TIR lenses.

6. The lighting apparatus of claim 4, wherein the second LED module comprises multiple LED units surrounding the first LED module.

7. The lighting apparatus of claim 6, wherein a separate LED unit is disposed on the plastic unit facing to each LED unit.

8. The lighting apparatus of claim 7, wherein the multiple separate LED units form a tilt angle for directing light.

9. The lighting apparatus of claim 8, wherein the plastic cover is rotatable with respect to a main housing that holds the light source plate to change a tilt direction of a mixed output light of the first LED module and the second LED module.

10. The lighting apparatus of claim 1, wherein the controller adjusts a ratio between the first driving current and the second driving current according to a manual switch.

11. The lighting apparatus of claim 10, further comprising a main housing, wherein the main housing and the plastic cover together enclose the light source plate, wherein the manual switch is disposed on an exterior surface of the main housing.

12. The lighting apparatus of claim 10, further comprising handle, wherein a portion of the handle is disposed on an exterior surface of the main housing, wherein the handle is operable to move the light source plate to adjust a relative distance between the first LED module to the plastic cover.

13. The lighting apparatus of claim 12, wherein the main housing has a sliding track for the light source plate to move along a light output direction of the first LED module.

14. The lighting apparatus of claim 1, further comprising a reflection cup, wherein a bottom end of the reflection cup has a smaller diameter than a top end of the reflection cup, wherein the reflection cup separates the first LED module from the second LED module.

15. The lighting apparatus of claim 14, wherein the first light spanning region forms a light beam, wherein the second light spanning region forms a diffusion light.

16. The lighting apparatus of claim 1, wherein the controller has a first working mode in which the second LED module is completely disabled for producing the light beam.

17. The lighting apparatus of claim 16, wherein the controller has a second working mode, in which the second LED module is turned on to emit a second light with a second light intensity have less than 20% of difference from a first light from the first LED module.

18. The lighting apparatus of claim 1, wherein the second LED module has a smaller color temperature than the first LED module.

19. The lighting apparatus of claim 1, wherein the plastic cover has a hook lens, wherein the hook lens engages the light source plate and has a reverse hook to fix to the light source plate.

20. The lighting apparatus of claim 19, wherein the plastic cover engages an edge of the main housing at a edge connection, wherein the edge connection and the reverse hook together fix the plastic hook to the main housing.
